(19) United States
(12) Patent Application Publication
(10) Pub. No.: US 2012/0273565 A1
(43) Pub. Date: Nov. 1, 2012

(54) METHOD, DEVICE AND SYSTEM FOR STORING SOCIAL NETWORKING SERVICES CONTENT

(75) Inventor: Chao Lin, Shenzhen City (CN)

(73) Assignee: TENCENT TECHNOLOGY (SHENZHEN) COMPANY LIMITED, Shenzhen City, Guangdong Province (CN)

(21) Appl. No.: 13/498,135

(22) PCT Filed: Jan. 11, 2011
(86) PCT No.: PCT/CN11/70168

§ 371 Date: Mar. 23, 2012

(30) Foreign Application Priority Data
Jan. 12, 2010 (CN) 201010000564.7

(51) Int. Cl. G06F 17/40

(52) U.S. Cl. 235/375

(57) ABSTRACT

The present invention publishes a method, a device and a system for storing SNS content. The method includes the following steps. A personal mobile device gathers two-dimensional barcode information from a computer and restores it into SNS information, wherein the SNS information includes SNS content, and the two-dimensional barcode information is obtained by converting the SNS information fetched from a SNS community with the computer. The personal mobile device stores the SNS content. The present invention improves the efficiency an accuracy of storing SNS content, and can further store the SNS content in a corresponding space according to the SNS type of the SNS content such that user can directly use the SNS content. For example, the user may directly dial the phone number in a contact list, or click a URL. The operation is simple and convenient, and the user's using experience is good.

### FIELD OF THE INVENTION

The present invention relates to information storing, and more particularly to a method, a device and a system for storing social networking services content.

### BACKGROUND OF THE INVENTION

Social networking services (SNS) are internet applications for helping people to create social networks. The content in SNS communities is called SNS content. SNS content is increasingly rich, and is gradually changing from original anonymous form to the current real name form. For example, in http://www.renren.com, any user should register with real name before using the services. Thus, after drawing useful SNS content from SNS communities, how to storing such SNS content becomes urgent needs of users.

Currently, there are two methods for storing the SNS content, the first one is to store the SNS content in computers and the second one is to input the SNS content into a personal mobile device manually.

The security of the first storing method is relatively low. For example, the computers used by the users may be public computers or computers temporarily borrowed from others, thus, if the SNS content is stored in these computers, other users may access the stored SNS content. Therefore, the method is insufficient for protecting the security of the SNS content.

The second storing method stores the SNS content in users' personal mobile devices. Although the second storing method has better security compared with the first storing method; however, due to using manual storing manner, the efficiency and accuracy are relatively low. Moreover, SNS content in image formats can't stored by the manual manner.

In summary, under the premise of ensuring the security of the SNS content, current methods for storing SNS content are inefficient and inaccurate, and can't storing SNS content in image formats.

### SUMMARY OF THE INVENTION

To improve the efficiency and accuracy of storing SNS content, embodiments of the present invention provide a method, a device and a system for storing SNS content.

To solve aforementioned problems, technical solutions provided by embodiments of the present invention are achieved as follows:

A method for storing SNS content includes the following steps. A personal mobile device gathers two-dimensional barcode information from a computer, and restores the two-dimensional barcode information into SNS information, wherein the SNS information includes SNS content, and the two-dimensional barcode information is obtained by converting the SNS information fetched from a SNS community with the computer. The personal mobile device stores the SNS content.

The SNS content may further includes: a SNS type of the SNS content; correspondingly, the personal mobile device storing the SNS content includes: according to the SNS type, the personal mobile device storing the SNS content in a corresponding space therein.

The personal mobile device storing the SNS content in the corresponding space therein according to the SNS type includes:

when the SNS type is of a contact list, the personal mobile device storing the SNS content in a contact list storing unit of the personal mobile device; or,

when the SNS type is of an image, the personal mobile device storing the SNS content in an image storing unit; or

when the SNS type is of a uniform resource locator (URL), the personal mobile device storing the SNS content in a URL storing unit; or

when the SNS type is of a document, the personal mobile device storing the SNS content in a document storing unit.

After the personal mobile device storing the SNS content in the corresponding space therein according to the SNS type, the method further includes: the personal mobile device displaying the SNS content in a form corresponding to the space storing the SNS content.

A personal mobile device for storing SNS content, includes:

a restoring module, configured for gathering two-dimensional barcode information from a computer, restoring the two-dimensional barcode information into SNS information, wherein the SNS information includes SNS content, the two-dimensional barcode information is obtained by converting SNS information fetched from a SNS community with the computer; and

a storing module, configured for storing the SNS content from the restoring module.

The storing module, specifically, is used for: when the SNS information further includes the SNS type of the SNS content, according to the SNS type, storing the SNS content restored by the restoring module in a corresponding space therein.

The storing module includes at least one of a contact list storing unit, an image storing unit, a URL storing unit, and a document storing unit;

The contact list storing unit is configured for storing the SNS content restored by the restoring module when the SNS type is of a contact list;

The image storing unit is configured for storing the SNS content restored by the restoring module when the SNS type is of an image;

The URL storing unit is configured for storing the SNS content restored by the restoring module when the SNS type is of a URL;

The document storing unit is configured for storing the SNS content restored by the restoring module when the SNS type is of a document.

The personal mobile device further includes a displaying module, configured for displaying the SNS content in a form corresponding to the space storing the SNS content.

A system for storing SNS content, including: a computer and a personal mobile device;

The computer is configured for gathering SNS information from a SNS community, and converting the SNS information into two-dimensional barcode information, wherein the SNS information includes SNS content;

The personal mobile device is configured for gathering the two-dimensional barcode information from the computer, restoring the two-dimensional barcode information into the SNS information, and storing the SNS content.

The personal mobile device, is further configured for, when the SNS information further includes the SNS type of the SNS content, storing the SNS content in a corresponding storing space in the personal mobile device according to the SNS type.

The personal mobile device, specifically, is configured for:

when the SNS type is of a contact list, storing the SNS content in a contact list storing unit; or,

when the SNS type is of an image, storing the SNS content in an image storing unit; or,

when the SNS type is of a URL, storing the SNS content in a URL storing unit; or,

when the SNS type is of a document, storing the SNS content in a document storing unit.

The personal mobile device is further configured for displaying the SNS content in a form corresponding to the space storing the SNS content.

The technical solutions provided by the embodiments of the present invention have the following advantages.

The personal mobile device gathers the two-dimensional barcode information from the computer, restores the two-dimensional barcode information into SNS information including the SNS content, and storing the SNS content. The two-dimensional barcode information is obtained by fetching the SNS information from the SNS community and converting the SNS information with the computer. Under the premise of ensuring the security of the SNS content, the efficiency and accuracy of storing the SNS content is improved, and it is helpful to store SNS content of high information content or images that can't be inputted manually.

In addition, the SNS content may further include the SNS type; the personal mobile device can store the SNS content in a corresponding space therein according to the SNS type, such that the user can directly use the SNS content, for example, dialing the phone number in the contact list, or directly clicking the URL etc. The operation is simple and convenient; the user's using experience is better.

### BRIEF DESCRIPTION OF THE DRAWINGS

FIG. 1 is a flow chart showing a method for storing SNS content provided by a first embodiment of the present invention;

FIG. 2 is a flow chart showing a method for storing a contact list provided by the first embodiment of the present invention;

FIG. 3 is a schematic view showing a contact list provided by the first embodiment of the present invention;

FIG. 4 is a schematic view showing a two-dimensional barcode provided by the first embodiment of the present invention;

FIG. 5 is a schematic view showing launching the QuickMark™ provided by the first embodiment of the present invention;

FIG. 6 is a schematic view showing gathering with the QuickMark™ provided by the first embodiment of the present invention;

FIG. 7 is a flow chart showing another method for storing a contact list provided by the first embodiment of the present invention;

FIG. 8 is a schematic view showing displaying the contact list provided by the first embodiment of the present invention;

FIG. 9 is a schematic diagram showing a personal mobile device for storing SNS content provided by a second embodiment of the present invention;

FIG. 10 is another schematic diagram showing the personal mobile device for storing SNS content provided by the second embodiment of the present invention; and

FIG. 11 is a schematic view showing a system for storing SNS content provided by a third embodiment of the present invention.

### DETAILED DESCRIPTION OF PREFERRED EMBODIMENTS

To make the objective, the technical solutions and advantages of the present invention more apparently, embodiments of the present invention will be described in detail accompanying with figures as follows.

### Embodiment 1

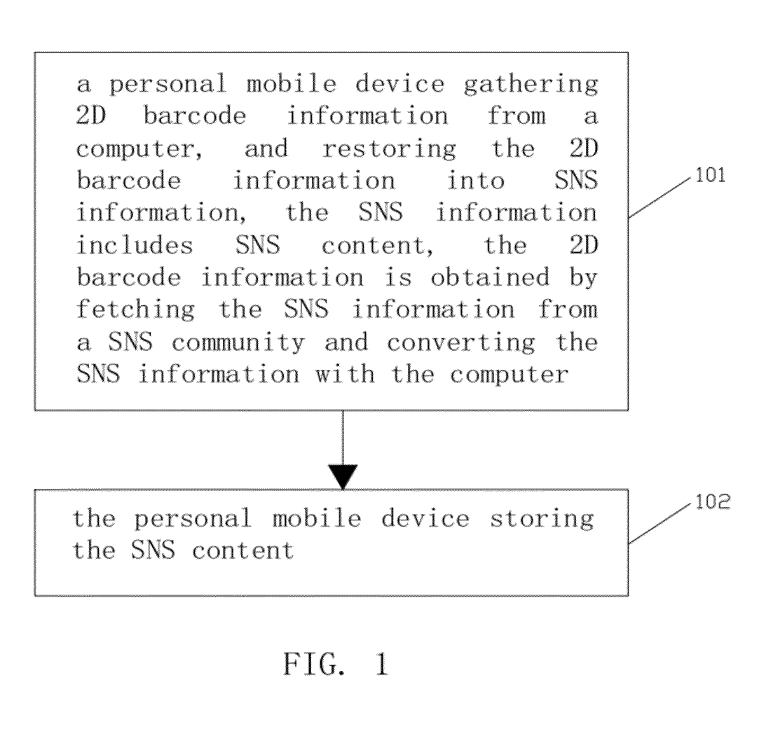

Referring to FIG. 1, the present embodiment provides a method for storing SNS content which includes the following steps:

Step 101: a personal mobile device gathers two-dimensional barcode information from a computer and restores the two-dimensional (2D) barcode information into SNS information, wherein the SNS information include SNS content, and the two-dimensional bar code information is obtained by fetching the SNS information from a SNS community and converting the SNS information with the computer;

In step 101, the personal mobile device includes, but not limited to, mobile phones.

In addition, the SNS content further includes a SNS type of the SNS content. The SNS type includes, but not limited to, a contact list, an image, a URL or a document.

Step 102, the personal mobile device stores the SNS content.

Furthermore, the personal mobile device stores the SNS content in a corresponding space therein according to the SNS type. Specifically,

when the SNS type is of a contact list, the personal mobile device stores the SNS content in a contact list storing unit; or,

when the SNS type is of an image, the personal mobile device storing the SNS content in an image storing unit; or

when the SNS type is of a uniform resource locator (URL), the personal mobile device storing the SNS content in a URL storing unit; or

when the SNS type is of a document, the personal mobile device storing the SNS content in a document storing unit.

Furthermore, the personal mobile device displays the SNS content in a form corresponding to the space storing the SNS content.

In the method provided by the present embodiment, the personal mobile device gathers the two-dimensional barcode information from the computer, and restores the two-dimensional barcode information into SNS information including the SNS content. The two-dimensional barcode information is obtained by fetching the SNS information from the SNS community and converting the SNS information with the computer. Under the premise of ensuring the security of the SNS content, the efficiency and accuracy of storing the SNS content is improved, and it is also helpful to store SNS content of high information content or images that can't be inputted manually. Furthermore, the SNS information may further include the SNS type; the SNS content can be stored in a corresponding space in the personal mobile device according to the SNS type such that the user can directly use the SNS content. For example, the user may directly dial a phone number in the contact list, or directly click a URL. The operation is simple and convenient; and the user's using experience is good.

In following context, the method is further described taking the contact list as an example, SNS content of other SNS type is similar and is not described in detail for concise consideration.

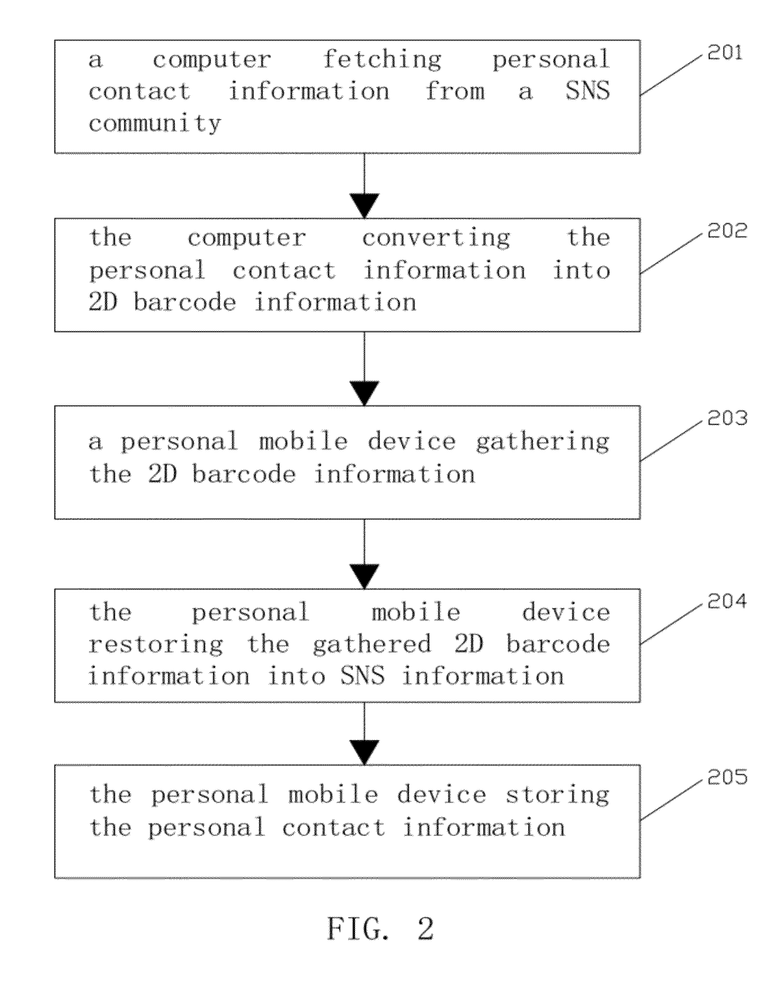

Referring to FIG. 2, the present embodiment provides a method for storing SNS content, in which the SNS information includes the SNS type. The method includes the following steps.

Step 201, a computer fetches personal contact information from a SNS community;

In step 201, the personal contact information is the SNS content. The computer, for example, is a server of the SNS community or a client visiting the SNS community, and the present embodiment doesn't make any restrict.

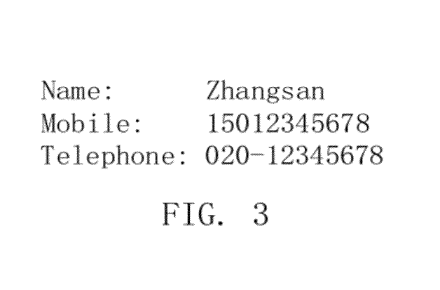

Referring to FIG. 3, illustrated is the personal contact information of “Zhangsan”, which includes the name, mobile phone number and family telephone number. The above listed entities are only exemplary, and the present embodiment doesn't make any restrict to the specific content of the personal contact information.

Step 202, the computer converts the personal contact information into two-dimensional barcode information;

For example, the two-dimensional barcode information is generated according to the two-dimensional barcode protocol and format by dynamic webpage programming languages such as common gateway interface (CGI), hypertext preprocessor (PHP), java server pages (JPS) etc.

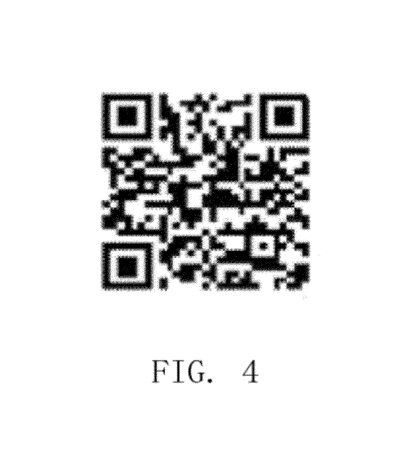

Referring to FIG. 4, illustrated is the obtained two-dimensional barcode information after the personal contact information of “Zhangsan” is converted.

If the user doesn't have any personal mobile device at the time, after encrypted, the two-dimensional barcode information can be saved in public computers or others' computers. To some extent, this is helpful to ensure the information security.

Step 203, a personal mobile device gathers the two-dimensional barcode information from the computer.

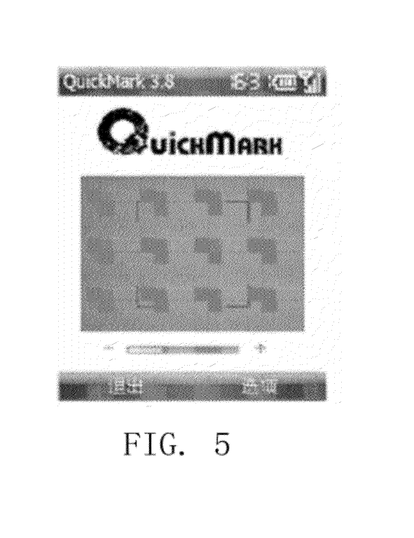

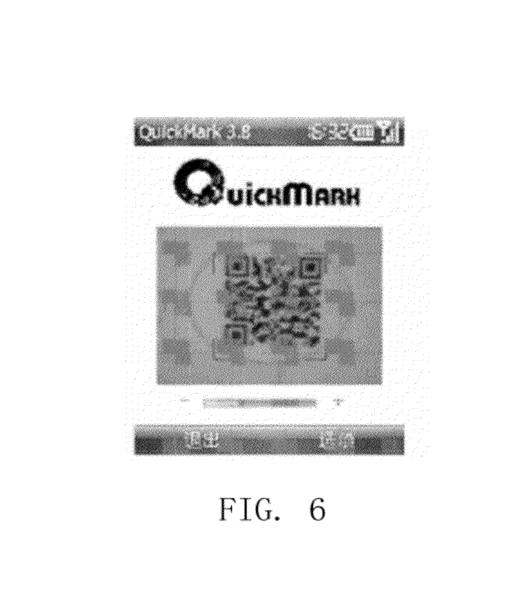

In step 203, the personal mobile device includes, but not limited to, a mobile phone. Gathering the two-dimensional barcode information can be achieved by a two-dimensional barcode scanning software and a camera installed in the personal mobile device. The two-dimensional barcode scanning software, for example, is QuickMark™; however, the present embodiment doesn't make any restrict on the two-dimensional barcode scanning software. As shown in FIG. 5, QuickMark™ is launched. Referring to FIG. 6, the camera is aligned with the two-dimensional barcode information to perform the gathering process.

Step 204, the personal mobile device restores the gathered two-dimensional barcode information into the personal contact information.

Step 205, the personal mobile device stores the personal contact information.

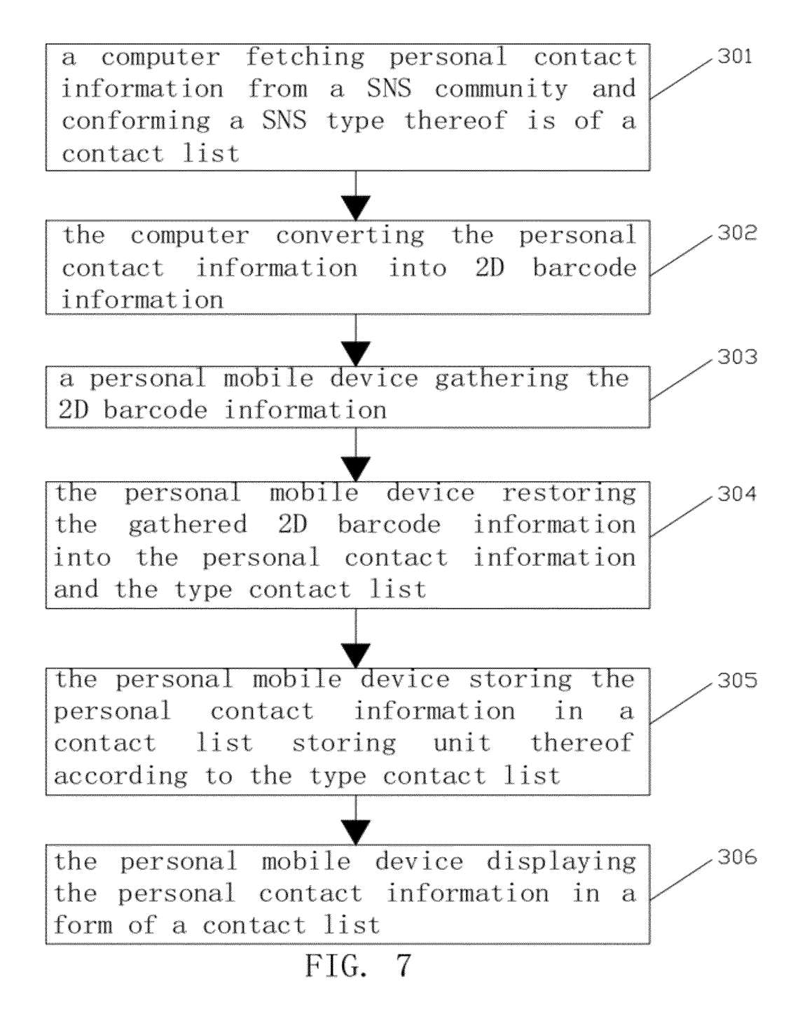

Referring to FIG. 7, the present embodiment provides a method for storing SNS content, in which the SNS information includes SNS content and the SNS type thereof, the method includes the following steps:

Step 301, a computer fetches personal contact information from a SNS community and conforming the SNS type is of a contact list;

In step 301, the limitation to the personal contact information and the computer can be referred to step 201, and are not further described here.

Specifically, the method for conforming the SNS type of the SNS content includes, but not limited to: conforming the SNS type to be contact list according to the position of the SNS content in the SNS community, for example, if the SNS content is contained in the contact list of the SNS community, the SNS type is of a contact list; conforming the SNS type to be URL, image or document according to predetermined format of the SNS content. For example, if the SNS content contains “http://”, the SNS type is of a URL; if the SNS content contains suffix .jpg, .gif, .bmp etc. the SNS type is of an image; if the SNS content contains suffix .doc, the SNS type is of a document, and the other examples are not enumerated.

Step 302, the computer converts the personal contact information and the type “contact list” into two-dimensional barcode information;

In step 302, the specific converting manner can be referred to step 202, and is not described here for concise. Referring to FIG. 4, illustrated is the two-dimensional barcode information converted from the personal contact information and the type “contact list” of “Zhangsan” shown in FIG. 3.

Step 303, the personal mobile device gathers the two-dimensional barcode information from the computer.

In step 303, the specific gathering manner can be referred to step 203, and is not described here for concise.

Step 304, the personal mobile device restores the gathered two-dimensional barcode information into the personal contact information and the type “contact list”.

Step 305, the personal mobile device stores the personal contact information in a contact list storing unit according to the type “contact list”.

Step 306, the personal mobile device displays the personal contact information in a form of a contact list;

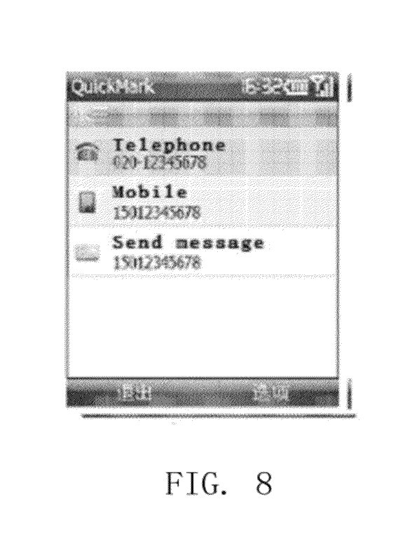

Referring to FIG. 8, illustrated is a displayed interface of the personal contact information of “Zhangsan”, and the user can directly dial the phone number in the contact list.

In the method provided by the present embodiment, the personal mobile device gathers the two-dimensional barcode information from the computer, restores the two-dimensional barcode information into SNS information including the SNS content, and stores the SNS content. The two-dimensional barcode information is obtained by fetching the SNS information from the SNS community and converting the SNS information with the computer. Under the premise of ensuring the security of the SNS content, the efficiency and accuracy of storing the SNS content is improved, and it is also helpful to store SNS content of high information content or images that can't be inputted manually. Furthermore, the SNS information may further include the SNS type; the SNS content can be stored in a corresponding space in the personal mobile device according to the SNS type such that the user can directly use the SNS content. For example, the user may directly dial a phone number in the contact list, or directly click a URL. The operation is simple and convenient; and the user's using experience is good.

### Embodiment 2

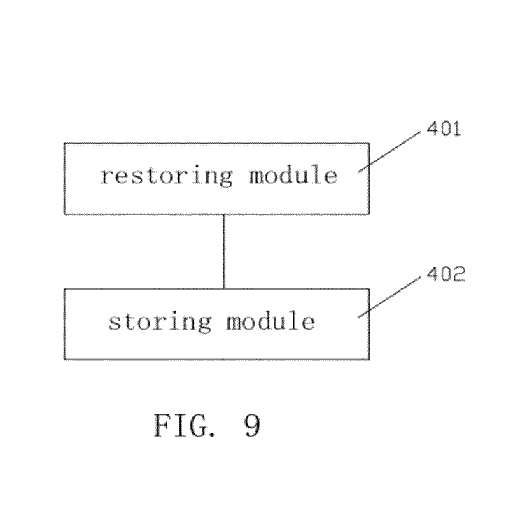

Referring to FIG. 9, the present embodiment provides a personal mobile device for storing SNS content, which includes:

A restoring module 401, is configured for gathering two-dimensional barcode information from a computer and restoring the two-dimensional barcode information into SNS information, wherein the SNS information includes SNS content, and the two-dimensional barcode information is obtained by fetching the SNS information from a SNS community and converting the SNS information;

A storing module 402 is configured for storing the SNS content restored by the restoring module 40.

In detail, the storing module 402 is used to store the SNS content in a corresponding space in the personal mobile device according to the SNS type when the SNS information includes the SNS type of the SNS content.

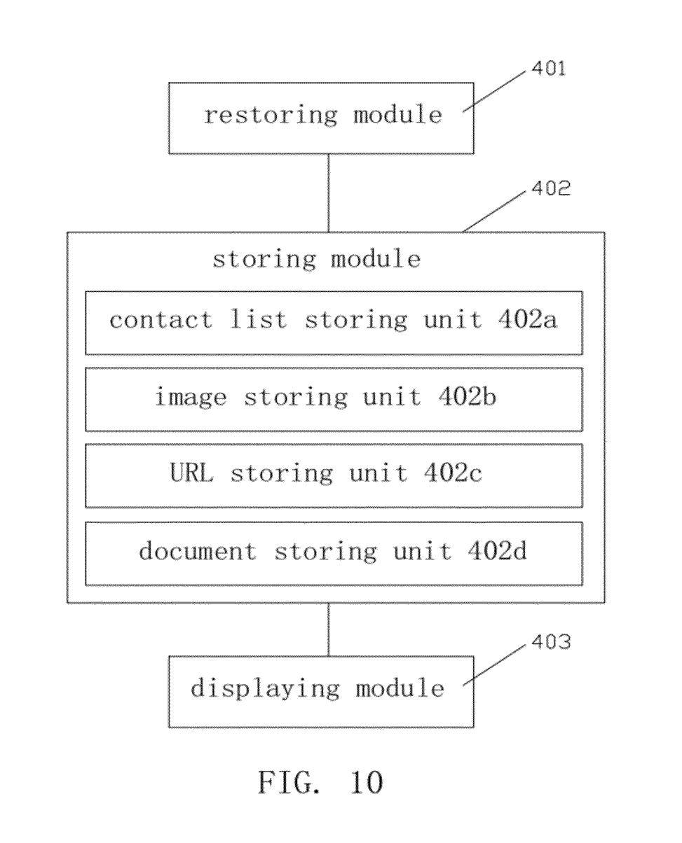

Referring to FIG. 10, the storing module 402 includes at least one of: a contact list storing unit 402a, an image storing unit 402b, a URL storing unit 402c, and a document storing unit 402d.

The contact list storing unit 402a, is configured for storing the SNS content restored by the restoring module 401 when the SNS type is of a contact list;

The image storing unit 402b, is configured for storing the SNS content restored by the restoring module 401 when the SNS type is of an image;

The URL storing unit 402c, is configured for storing the SNS content restored by the restoring module 401 when the SNS type is of a URL;

The document storing unit 402d is configured for storing the SNS content restored by the restoring module 401 when the SNS type is of a document.

The personal mobile device further includes: a displaying module 403, configured for displaying the SNS content in a form corresponding to the space in the storing module 402.

The personal mobile device provided by the present embodiment gathers the two-dimensional barcode information from the computer, restores the two-dimensional barcode information into SNS information including the SNS content, and stores the SNS content. The two-dimensional barcode information is obtained by fetching the SNS information from the SNS community and converting the SNS information with the computer. Under the premise of ensuring the security of the SNS content, the efficiency and accuracy of storing the SNS content is improved, and it is also helpful to store SNS content of high information content or images that can't be inputted manually. Furthermore, the SNS information may further include the SNS type; the SNS content can be stored in a corresponding space in the personal mobile device according to the SNS type such that the user can directly use the SNS content. For example, the user may directly dial a phone number in the contact list, or directly click a URL. The operation is simple and convenient; and the user's using experience is good.

### Embodiment 3

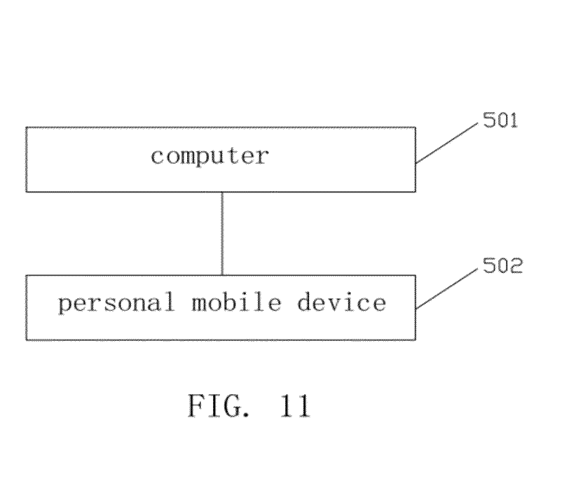

Referring to FIG. 11, the present embodiment provides a system for storing SNS content, which includes: a computer 501 and a personal mobile device 502;

The computer 501 is configured for fetching SNS information from a SNS community, and converting the SNS information into two-dimensional barcode information, the SNS information includes SNS content;

The personal mobile device 502, is configured for gathering the two-dimensional barcode information from the computer 501, restores the two-dimensional barcode information into the SNS information, and stores the SNS content.

The personal mobile device is further configured for storing the SNS content in a corresponding space in the personal mobile device 502 according to the SNS type when the SNS information further includes the SNS type.

The personal mobile device, specifically, is configured for, when the SNS type is of a contact list, storing the SNS content in a contact list storing unit of the personal mobile device 502; or,

When the SNS type is of an image, storing the SNS content in an image storing unit of the personal mobile device 502; or,

When the SNS type is of a URL, storing the SNS content in a URL storing unit of the personal mobile device 502; or,

When the SNS type is of a document, storing the SNS content in a document storing unit.

The personal mobile device 502 is further configured for displaying the SNS content in a form corresponding to the space storing the SNS content.

In the system provided by the present embodiment, the computer fetches the SNS information from the SNS community, and converts the SNS information into the two-dimensional barcode information. The SNS information includes the SNS content. The personal mobile device gathers the two-dimensional barcode information from the computer, restores the two-dimensional barcode information into the SNS information including the SNS content, and stores the SNS content. Under the premise of ensuring the security of the SNS content, the efficiency and accuracy of storing the SNS content is improved, and it is also helpful to store SNS content of high information content or images that can't be inputted manually. Furthermore, the SNS information may further include the SNS type; the SNS content can be stored in a corresponding space in the personal mobile device according to the SNS type such that the user can directly use the SNS content. For example, the user may directly dial a phone number in the contact list, or directly click a URL. The operation is simple and convenient; and the user's using experience is good.

All or part of the technique solutions provided by the above embodiments can be achieved by programming, and the program can be stored in a computer readable storing medium such as, hard disk drives, compact disks, or soft disk drives.

The above descriptions are only preferred embodiments of the present invention, and are not intended to limit the present invention. Any amendments, replacement and modification made to the above embodiments under the spirit and principle of the present invention should be included in the scope of the present invention.

1. A method for storing social networking services (SNS) content, wherein the method comprises:
a personal mobile device gathering two-dimensional barcode information from a computer, and restoring the two-dimensional barcode information into SNS information, wherein the SNS information includes SNS content, and the SNS information is obtained by fetching the SNS information from a SNS community and converting the SNS information with the computer; and
the personal mobile device storing the SNS content.

2. The method as claimed in claim 1, wherein:
the SNS information further comprises: a SNS type of the SNS content;
accordingly, the personal mobile device storing the SNS content comprising:
the personal mobile device storing the SNS content in a corresponding space therein according to the SNS type.

3. The method as claimed in claim 2, wherein the personal mobile device storing the SSN content in a corresponding space therein according to the SNS type comprises:
when the SNS type is of a contact list, the personal mobile device storing the SNS content in a contact list storing unit; or
when the SNS type is of an image, the personal mobile device storing the SNS content in an image storing unit; or
when the SNS type is of a URL (Universal Resource Locator), the personal mobile device storing the SNS content in a URL storing unit; or
when the SNS type is of a document, the personal mobile device storing the SNS content in a document storing unit.

4. The method as claimed in claim 3, wherein after the personal mobile device storing the SSN content in a corresponding space therein according to the SNS type, the method further comprises:
the personal mobile device displaying the SNS content in a form corresponding to the space.

5. A personal mobile device for storing social networking services (SMS) content, wherein the personal mobile device comprises:
a restoring module, configured for gathering two-dimensional barcode information from a computer, and restoring the two-dimensional barcode information into SNS information, wherein the SNS information comprises SNS content, and the two-dimensional information is obtained by fetching the SNS information from a SNS community and converting the SNS information with the computer; and
a storing module, configured for storing the SNS content restored from the restoring module.

6. The personal mobile device as claimed in claim 5, wherein the storing module is configured for storing the SNS content in a corresponding space of the personal mobile device according to the SNS type when the SNS information comprises the SNS type of the SNS content.

7. The personal mobile device as claimed in claim 6, wherein the storing module comprises at least one of a contact list storing unit, an image storing unit, a URL (Universal Resource Locator) storing unit, and a document storing unit;
the contact list storing unit is configured for storing the SNS content when the SNS type is of a contact list;
the image storing unit is configured for storing the SNS content when the SNS type is of an image;
the URL storing unit is configured for storing the SNS content when the SNS type is of a URL;
the document storing unit is configured for storing the SNS content when the SNS type is of a document.

8. The personal mobile device as claimed in claim 7, wherein the personal mobile device further comprises a displaying module configured for displaying the SNS content in a form corresponding to the space in the storing module.

9. A system for storing storing social networking services (SNS) content, characterized in that the system comprises a computer and a personal mobile device;
the computer is configured for fetching SNS information from a SNS community, and converting the SNS information into two-dimensional barcode information, wherein the SNS information comprises SNS content;
the personal mobile device is configured for gathering the two-dimensional barcode information from the computer, restoring the two-dimensional barcode information into the SNS information, and storing the SNS content.

10. The system as claimed in claim 9, wherein the personal mobile device is further configured for storing the SNS content in a corresponding space therein according the a SNS type when the SNS information comprises the SNS type.

11. The system as claimed in claim 10, wherein the personal mobile device is configured for:
when the SNS type is of a contact list, storing the SNS content in a contact list storing unit; or
when the SNS type is of an image, the SNS content in an image storing unit; or
when the SNS type is of a URL (Universal Resource Locator), storing the SNS content in a URL storing unit; or
when the SNS type is of a document, storing the SNS content in a document storing unit.

12. The system as claimed in claim 11, wherein the personal mobile device is further configured for displaying the SNS content in a form corresponding to the space storing the SNS content.

13. The system as claimed in claim 10, wherein the personal mobile device is further configured for displaying the SNS content in a form corresponding to the space storing the SNS content.

14. The personal mobile device as claimed in claim 6, wherein the personal mobile device further comprises a displaying module configured for displaying the SNS content in a form corresponding to the space in the storing module.

15. The method as claimed in claim 2, wherein after the personal mobile device storing the SSN content in a corresponding space therein according to the SNS type, the method further comprises:
the personal mobile device displaying the SNS content in a form corresponding to the space.

16. A computer readable medium storing instructions for directing a method for storing social networking services (SNS) content, wherein the instructions comprises:
an instruction causing a personal mobile device to gather two-dimensional barcode information from a computer, and restore the two-dimensional barcode information into SNS information, wherein the SNS information includes SNS content, and the SNS information is obtained by fetching the SNS information from a SNS community and converting the SNS information with the computer; and
an instruction causing the personal mobile device storing the SNS content.

17. The computer readable medium as claimed in claim 16, wherein:
the SNS information further comprises: a SNS type of the SNS content;
accordingly, the instructions comprises a instruction causing the personal mobile device to store the SNS content in a corresponding space therein according to the SNS type.

18. The computer readable medium as claimed in claim 17, wherein the personal mobile device storing the SSN content in a corresponding space therein according to the SNS type comprises:
when the SNS type is of a contact list, the personal mobile device storing the SNS content in a contact list storing unit; or
when the SNS type is of an image, the personal mobile device storing the SNS content in an image storing unit; or
when the SNS type is of a URL (Universal Resource Locator), the personal mobile device storing the SNS content in a URL storing unit; or
when the SNS type is of a document, the personal mobile device storing the SNS content in a document storing unit.

19. The computer readable medium as claimed in claim 18, wherein the instructions further comprises an instruction causing the personal mobile device to display the SNS content in a form corresponding to the space after the personal mobile device storing the SSN content in a corresponding space therein according to the SNS type.

20. The computer readable medium as claimed in claim 17, wherein the instructions further comprises an instruction causing the personal mobile device to display the SNS content in a form corresponding to the space after the personal mobile device storing the SSN content in a corresponding space therein according to the SNS type.
